(19) United States
(12) Patent Application Publication
(10) Pub. No.: US 2025/0320389 A1
(43) Pub. Date: Oct. 16, 2025

(54) COMPOSITION BASED ON (METH)ACRYLATE COMPOUNDS

(71) Applicants: Bostik SA, COLOMBES (FR); Universite De Haute-Alsace, MULHOUSE CEDEX (FR); Centre National De La Recherche Scientifique, PARIS (FR)

(72) Inventors: Jérôme MAZAJCZYK, VENETTE (FR); Alexis BARRAT, VENETTE (FR); Frédéric SIMON, VENETTE (FR); Jacques LALEVEE, MULHOUSE (FR); Stéphane FOUQUAY, Mont Saint Aignan (FR)

(21) Appl. No.: 18/867,873

(22) PCT Filed: May 30, 2023
(86) PCT No.: PCT/FR2023/050750

§ 371 Date: Nov. 21, 2024

(30) Foreign Application Priority Data
May 31, 2022 (FR) FR2205202

(51) Int. Cl. C09J 133/14; C08F 120/16; C08F 120/28; C09J 5/00; C09J 9/02; C09J 133/10

(52) U.S. Cl. CPC C09J 133/14; C08F 120/16; C08F 120/28; C09J 5/00; C09J 9/02; C09J 133/10

(57) ABSTRACT

Composition based on (meth)acrylate compounds

The present invention relates to a crosslinkable two-component composition comprising:
a component A comprising:
   an organocopper derivative;
   at least one (meth)acrylate compound M1;
      on condition that when the organocopper derivative is not halogenated, then component A also comprises a halogenated carboxylic acid;
a component B comprising at least one compound having the formula (VI) below:

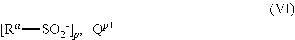

and also to the uses thereof.

### FIELD OF THE INVENTION

The present invention relates to a composition based on (meth)acrylate compounds. The invention also relates to the use of said composition in the repair and/or the semi-structural or structural adhesive bonding of materials, for example in the transportation, marine, assembly, electronics or construction field.

### TECHNOLOGICAL BACKGROUND

Acrylic compositions are known reactive systems which crosslink by radical polymerization. They are used as adhesives, mastics and coatings. Radical polymerization is typically initiated by a redox system which, by means of an oxidation-reduction reaction, results in the production of radicals.

Most acrylic systems are two-component systems. The first component conventionally contains the reducing agent and the reactive monomers, and the second component contains the oxidizing agent. Once the two components have been mixed, the reducing agent induces cleavage of the O—O bond of the organic peroxide for example, and initiates polymerization.

Most of the current acrylic systems use peroxide/amine couples to initiate the redox reaction. However, these systems suffer from a number of drawbacks, including stability problems, poor reactivity, notably with long open times, a lack of versatility, etc.

There is a need for novel compositions allowing one or more of these drawbacks to be at least partly overcome.

There is notably a need for novel compositions having high reactivity (high cohesion build-up), irrespective of the associated open time.

### A. Composition

The present invention relates to a crosslinkable two-component composition comprising:
a component A comprising:
   an organocopper derivative;
   at least one (meth)acrylate compound M1;
      on condition that when the organocopper derivative of component A is not halogenated, then component A also comprises a halogenated carboxylic acid;
a component B comprising at least one compound having the formula (VI) below:

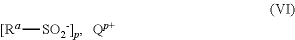

in which:
R^{a} represents an aryl or heteroaryl radical, said heteroaryl and aryl being optionally substituted with at least one of the following radicals: F, OH, C(O)OMe, NHC(O)Me, methyl (Me), CF₃, OH or SO₂;
Q represents Li, Na, K or Zn, preferably Na or K;
p represents 1 or 2.

In the context of the invention, the term “alkyl” means a linear or branched hydrocarbon-based radical preferably comprising from 1 to 20 carbon atoms. Mention may be made, for example, of methyl, ethyl and propyl.

In the context of the invention, the term “C4 to C20 alkyl” means a linear or branched alkyl comprising from 4 to 20 carbon atoms.

In the context of the invention, the term “alkenyl” means a linear or branched hydrocarbon-based radical including at least one double bond, said radical preferably comprising from 2 to 20 carbon atoms. Examples that may be mentioned include propenyl and butenyl.

In the context of the invention, the term “alkynyl” means a linear or branched hydrocarbon-based radical including at least one triple bond, said radical preferably comprising from 2 to 20 carbon atoms.

In the context of the invention, the term “aryl” means a monocyclic or bicyclic aromatic radical preferably comprising from 6 to 12 carbon atoms. Mention may be made, for example, of phenyl.

In the context of the invention, the term “arylalkyl” means an alkyl group substituted with an aryl group, the arylalkyl group preferably comprising from 7 to 20 carbon atoms. As an arylalkyl group, mention may be made, for example, of benzyl.

In the context of the invention, the term “alkylaryl” means an aryl group substituted with an alkyl group, said alkylaryl group preferably comprising from 7 to 20 carbon atoms.

In the context of the invention, the term “heteroaryl” means a monocyclic or bicyclic aromatic radical comprising at least one heteroatom, for instance O, S or N, and preferably comprising from 4 to 12 carbon atoms. Examples that may be mentioned include furanyl, thiophenyl, pyrrolyl, pyridinyl, indolyl or imidazolyl radicals.

In the context of the invention, the term “cycloalkyl” means a monocyclic or polycyclic, preferably monocyclic or bicyclic, saturated system preferably including from 3 to 12 carbon atoms, the rings possibly being bridged or fused in pairs, such as cyclopropyl, cyclopentyl, cyclohexyl or norbornyl groups.

In the context of the invention, the term “heterocycloalkyl” means a monocyclic or polycyclic, preferably monocyclic or bicyclic, saturated system, preferably including from 3 to 12 carbon atoms and at least one heteroatom, for instance O or N, the rings possibly being fused or bridged in pairs.

In the context of the invention, the term “cycloalkenyl” means a monocyclic or polycyclic system comprising at least one double bond, preferably including from 3 to 12 carbon atoms, the rings possibly being fused or bridged in pairs.

In the context of the invention, the term “alkoxy” means an-O-alkyl radical.

### Component A

### Organocopper Derivative

The composition according to the invention comprises an organocopper derivative, preferably an organocopper (II) derivative.

The organocopper derivative may be halogenated or non-halogenated. Preferably, the organocopper derivative is not halogenated.

The organocopper derivative may be chosen from the group formed from a copper salt of formula (VII-1) or a copper complex of formula (VII-2):

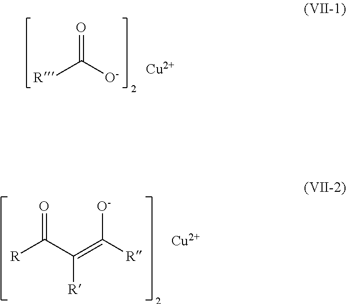

in which:
R and R″ each represent, independently of each other, an alkyl radical, a cycloalkyl radical, an aryl radical or a heteroaryl radical, said alkyl, cycloalkyl, aryl and heteroaryl radicals being optionally substituted with one or more halogen atoms, for instance with one or more fluorine atoms;
R′ represents a hydrogen atom, an alkyl radical, a cycloalkyl radical, an aryl radical or a heteroaryl radical,
   or R and R′ (or R′ and R″) may also be engaged in one and the same ring comprising from 5 to 8 carbon atoms, said ring optionally comprising at least one heteroatom (for instance O or S);
R′″ represents an alkyl radical, a cycloalkyl radical, an aryl radical or a heteroaryl radical, said alkyl, cycloalkyl, aryl and heteroaryl radicals being optionally substituted with one or more halogen atoms, for instance with one or more fluorine atoms.

Among the copper salts of formula (VII-1), mention may be made, for example, of copper(II) acetate (for example anhydrous or monohydrate), copper(II) monofluoroacetate, copper(II) difluoroacetate, copper(II) trifluoroacetate (for example anhydrous or monohydrate), copper(II) hexanoate, copper(II) ethyl-2-hexanoate, and mixtures thereof.

According to a preferred embodiment, in formula (VII-1), R′″ represents an alkyl radical containing from 1 to 20 carbon atoms, preferably from 1 to 7 carbon atoms, said alkyl being optionally substituted with one or more halogen atoms, for instance with one or more fluorine atoms.

Among the copper complexes of formula (VII-2), mention may be made, for example, of copper (II) hexafluoroacetylacetonate (Cu(hfacac)₂), copper (II) trifluoroacetylacetonate (Cu(tfacac)₂), copper(II) acetylacetonate (Cu(acac)₂) and copper(II) bis(2-acetylcyclohexanonate), respectively having the following formulae:

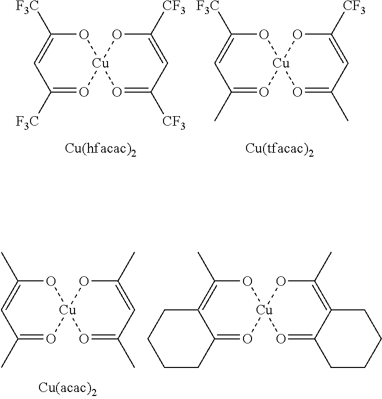

According to a preferred embodiment, in formula (VII-2):
R represents an alkyl radical, a cycloalkyl radical, an aryl radical or a heteroaryl radical, preferably an alkyl radical;
R′ represents a hydrogen;
R″ represents an alkyl radical optionally substituted with one or more halogen atoms, for instance one or more fluorine atoms.

The organocopper derivative is preferably a copper complex of formula (VII-2) and more particularly copper(II) acetylacetonate (Cu(acac)₂).

The total content of organocopper derivative(s), notably of formula (VII-1) or (VII-2), may range from 0.05% to 5% by weight, preferably from 0.1% to 2% by weight, and even more preferentially from 0.2% to 1% by weight relative to the total weight of the crosslinkable two-component composition.

### Halogenated Carboxylic Acid

According to the invention, when the organocopper derivative of component A as defined above is not halogenated, then component A also comprises a halogenated carboxylic acid.

It should be noted that when the organocopper derivative is halogenated, then component A may optionally comprise a halogenated carboxylic acid.

The halogenated carboxylic acid may be chosen from monohalogenated (comprising one halogen atom), dihalogenated (comprising two halogen atoms) or trihalogenated (comprising three halogen atoms) carboxylic acids.

The halogenated carboxylic acid may be chosen from the group formed from monochloroacetic acid, monofluoroacetic acid, dichloroacetic acid, difluoroacetic acid, trichloroacetic acid, trifluoroacetic acid, and mixtures thereof.

Preferably, the halogenated carboxylic acid is chosen from dichloroacetic acid, difluoroacetic acid and mixtures thereof.

When it is present, the total content of halogenated carboxylic acid(s) may range from 0.5% to 20% by weight, preferably from 0.5% to 10% by weight, and even more preferentially from 0.5% to 2% by weight relative to the total weight of the crosslinkable two-component composition.

### (Meth)acrylate Compound M1

Component A comprises at least one (meth)acrylate compound M1.

The (meth)acrylate compound M1 may be a (meth)acrylate monomer, a (meth)acrylate oligomer or a (meth)acrylate polymer.

Preferably, the (meth)acrylate compound M1 is a (meth)acrylate monomer.

The (meth)acrylate compound M1 may have the following formula (F):

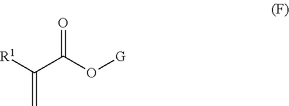

in which:
R¹ represents H or methyl;
G represents an organic radical.

Preferably, G is chosen from the group formed from alkyls, cycloalkyls, alkenyls, cycloalkenyls, alkylaryls, arylalkyls or aryls, said alkyls, cycloalkyls, alkenyls, cycloalkenyls, alkylaryls, arylalkyls and aryls being optionally substituted with, for example, alkyl or hydroxyl.

The (meth)acrylate compound M1 may have one of the formulae (I), (II), (III), (IV) or (V) below:

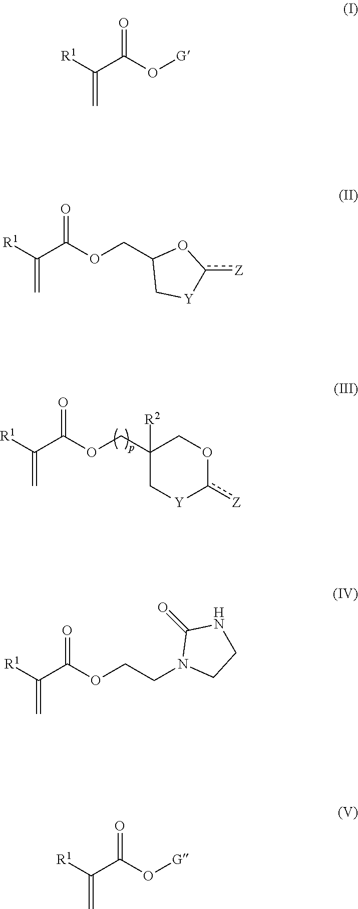

in which:
   R¹ represents H or methyl;
   R² represents H, methyl or ethyl;
   p represents 0 or 1; and
   Z represents H, O, S, an alkyl group, a benzyl group, an aryl group or an alkoxy group;
   Y represents O, S, NH or CH₂;
   [symbol] is a single or double bond,
   on condition that when Z represents O, then the bond [symbol] is a double bond;
G′ is chosen from the group formed from alkyls, cycloalkyls, alkenyls, cycloalkenyls, alkylaryls, arylalkyls or aryls, said alkyls, cycloalkyls, alkenyls, cycloalkenyls, alkylaryls, arylalkyls and aryls being optionally substituted with an alkyl group, said G′ group being characterized in that it does not comprise any heteroatoms;
   G″ is an alkyl substituted with an OH group.

In the abovementioned formula (I), G′ may be chosen from the group formed from C1-C20 alkyls, preferably C4-C20 alkyls, cycloalkyls, alkenyls, cycloalkenyls, alkylaryls, arylalkyls or aryls, said alkyls, cycloalkyls, alkenyls, cycloalkenyls, alkylaryls, arylalkyls and aryls being optionally substituted with an alkyl group, said group G′ being characterized in that it does not comprise any heteroatoms.

In the abovementioned formula (I), G′ is preferably chosen from the group formed from alkyls (preferably C1 to C20 and even more preferentially C4 to C20), cycloalkyls or aryls, said alkyls, cycloalkyls and aryls being optionally substituted with an alkyl group, said group G being characterized in that it does not comprise any heteroatoms. Preferably also, G′ is chosen from cycloalkyls.

Among the cycloalkyls, mention may be made, for example, of isobornyl, tert-butyl cyclohexyl, trimethylcyclohexyl, dicyclopentenyl and tricyclodecyl.

Among the compounds of formula (I), mention may be made, for example, of methyl (meth)acrylate, 2-ethylhexyl (meth)acrylate, n-butyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, bornyl (meth)acrylate, 2,3,4,5-tetra-t-butylcyclohexyl (meth)acrylate; benzyl (meth)acrylate, phenyl (meth)acrylate, 2-(2-ethoxyethoxy) ethyl (meth)acrylate, 2-phenoxyethyl (meth)acrylate, isobornyl (meth)acrylate, and mixtures thereof.

The preferred compounds M1 of formula (1) are as follows:

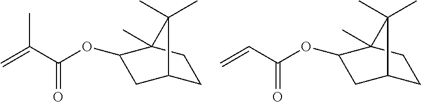

Among the compounds M1 of the abovementioned formula (II), mention may be made, for example, of the following monomers:

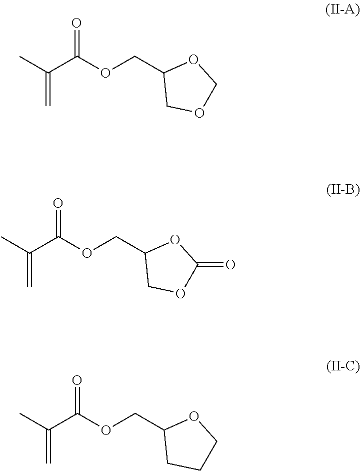

Among the compounds M1 of the abovementioned formula (III), mention may be made, for example, of the following monomers:

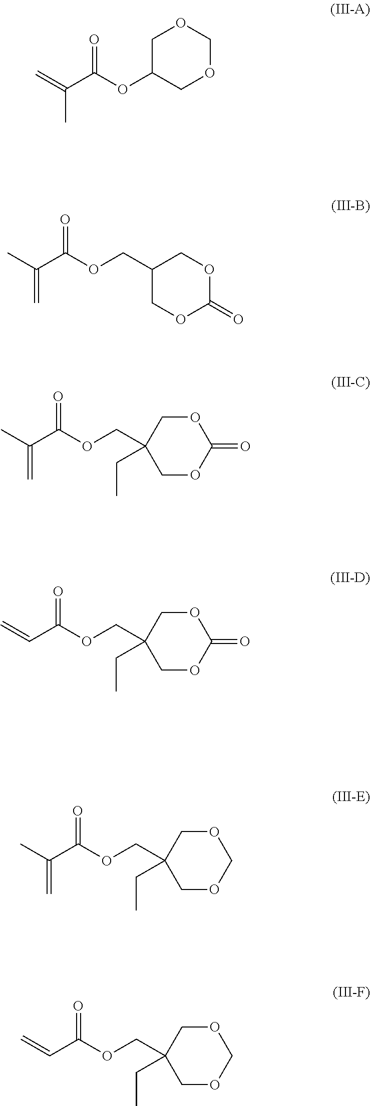 [SMILES: C=C(C)C(=O)OC1COCOC1 ; C=C(C)C(=O)OCC1COC(=O)OC1 ; C=C(C)C(=O)OCC1(CC)COC(=O)OC1 ; C=CC(=O)OCC1(CC)COC(=O)OC1 ; C=C(C)C(=O)OCC1(CC)COCOC1 ; C=CC(=O)OCC1(CC)COCOC1]

Among the compounds M1 of formula (II) or (III), the following monomers and mixtures thereof are preferred:

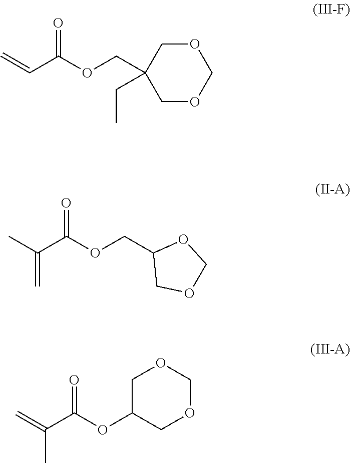

Among the compounds M1 of formula (V), mention may be made, for example, of hydroxyethyl (meth)acrylate and hydroxypropyl (meth)acrylate.

The total content of (meth)acrylate compound(s) M1 in component A may be greater than or equal to 5% by weight, preferably greater than or equal to 20% by weight, even more preferentially greater than or equal to 50% by weight and even more advantageously greater than or equal to 70% by weight relative to the total weight of said component A.

The content of (meth)acrylate compound(s) M1 in the crosslinkable two-component composition according to the invention may range from 5% to 99% by weight, preferably from 20% to 99%, even more preferentially from 50% to 99% by weight, and even more advantageously from 75% to 99% by weight relative to the total weight of said crosslinkable two-component composition.

The (meth)acrylate monomer M1 may or may not be a recycled monomer.

### Photoinitiator P1 (Optional)

Component A may also comprise a photoinitiator P1.

The photoinitiator may be any photoinitiator known to those skilled in the art. Under the action of UV-visible radiation, the photoinitiator typically generates radicals which are responsible for initiating the photopolymerization reaction, and notably allows the efficacy of the photopolymerization reaction to be increased. Needless to say, said photoinitiator is chosen as a function of the light source used, according to its ability to effectively absorb the selected radiation. For example, a suitable photoinitiator may be chosen on the basis of its UV-visible absorption spectrum. Advantageously, the photoinitiator is suitable for working with irradiation sources emitting in the near region from 300 to 420 nm. Advantageously, the source of UV or visible radiation may be an LED.

The photoinitiator P1 may be chosen from the group formed from:
type I photoinitiators chosen from:
   the family of acetophenones and alkoxyacetophenones, for instance 2,2-dimethoxy-2-phenylacetophenone and 2-diethyl-2-phenylacetophenone;
   the family of hydroxyacetophenones, for instance 2,2-dimethyl-2-hydroxyacetophenone, 1-hydroxycyclohexylphenyl ketone, 2-hydroxy-4′-(2-hydroxyethoxy)-2-methylpropriophenone and 2-hydroxy-4′-(2-hydroxypropoxy)-2-methylpropriophenone;
   the family of alkylaminoacetophenones, for instance 2-methyl-4′-(methylthio)-2-morpholinopropriophenone, 2-benzyl-2-(dimethylamino)-4-morpholinobutyrophenone and 2-(4-(methylbenzyl)-2-(dimethylamino)-4-morpholinobutyrophenone;
   the family of benzoin ethers, for instance benzil, benzoin methyl ether and benzoin isopropyl ether;
   the family of phosphine oxides, for instance diphenyl(2,4,6-trimethylbenzoyl)phosphine oxide (TPO), ethyl(2,4,6-trimethylbenzoyl)phenylphosphine oxide (TPO-L) and bis(2,6-dimethoxybenzoyl)-2,4,4-trimethylphenyl phosphine oxide (BAPO);
   the metallocene family, for instance ferrocene, titanium bis(eta⁵-2,4-cyclopentadien-1-yl)bis(2,6-difluoro)-3-(1H-pyrrol-1-yl)phenyl and iron (cumene)cyclopentadienyl hexafluorophosphate;
type II photoinitiators chosen from:
   the benzophenone family, for instance 4-phenylbenzophenone, 4-(4′-methylphenylthio)benzophenone and 1-[4-[(4-benzoylphenyl)thio]phenyl]-2-methyl-2-[(4-methylphenyl)sulfonyl]-1-propanone;
   the thioxanthone family, for instance isopropylthioxanthone (ITX), 2,4-diethylthioxanthone, 2,4-dimethylthioxanthone, 2-chlorothioxanthone and 1-chloro-4-isopropylthioxanthone;
   the family of benzoyl formate esters, for instance methylbenzoyl formate;
   the dibenzylidene ketone family, for instance p-dimethylamino ketone;
   the coumarin family, for instance 5-methoxy- and 7-methoxycoumarin, 7-diethylaminocoumarin and N-phenylglycine coumarin;
photoinitiators of the dye family, for instance triazines, fluorones, cyanines, safranines, 4,5,6,7-tetrachloro-3′,6′-dihydroxy-2′,4′,5′,7′-tetraiodo-3H-spiro[isobenzofuran-1,9′-xanthen]-3-one, pyrylium and thiopyrylium, thiazines, flavines, pyronines, oxazines and rhodamines;
and mixtures thereof.

According to a preferred embodiment, the photoinitiator P1 is chosen from:
the family of phosphine oxides, for instance diphenyl(2,4,6-trimethylbenzoyl)phosphine oxide (TPO), ethyl(2,4,6-trimethylbenzoyl)phenylphosphine oxide (TPO-L) and bis(2,6-dimethoxybenzoyl)-2,4,4-trimethylphenyl phosphine oxide (BAPO);
the thioxanthone family, for instance isopropylthioxanthone (ITX), 2,4-diethylthioxanthone, 2,4-dimethylthioxanthone, 2-chlorothioxanthone and 1-chloro-4-isopropylthioxanthone;
the photoinitiator P1 being even more preferentially chosen from diphenyl (2,4,6-trimethylbenzoyl)phosphine oxide (TPO) and ethyl(2,4,6-trimethylbenzoyl)phenylphosphine oxide (TPO-L).

The total content of photoinitiator P1 may range from 0% to 5% by weight, preferably from 0% to 2% by weight and even more preferentially from 0% to 1% by weight relative to the total weight of the crosslinkable two-component composition according to the invention.

If it is present in the two-component composition according to the invention, the photoinitiator content may be greater than or equal to 0.01%, for example greater than or equal to 0.1% by weight relative to the total weight of said composition.

### Component B

### Compound of Formula (VI)

Component B comprises at least one compound having the formula (VI) below:

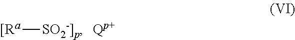

in which:
R^{a} represents an aryl or heteroaryl radical, said heteroaryl and aryl being optionally substituted with at least one of the following radicals: F, OH, C(O)OMe, NHC(O)Me, methyl (Me), CF₃, OH or SO₂;
Q represents Li, Na, K or Zn, preferably Na or K;
p represents 1 or 2.

The compound of formula (VI) may be chosen from the following compounds:

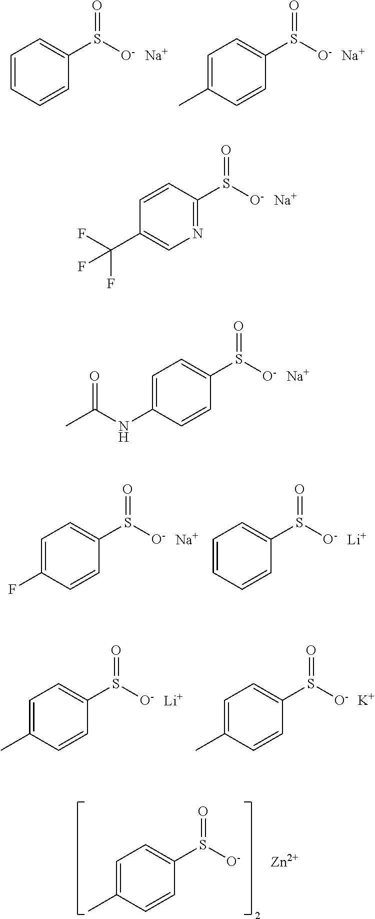

According to a preferred embodiment, the compound of formula (VI) is chosen from the following compounds:

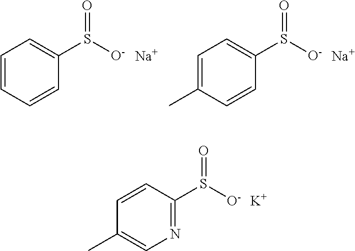

The total content of compound(s) of formula (VI) as defined above may range from 0.1% to 5.0% by weight, preferably from 0.1% to 3.0% by weight and even more preferentially from 0.2% to 1.5% by weight relative to the total weight of the crosslinkable two-component composition according to the invention.

### (Meth)acrylate Compounds

Component B may comprise one or more (meth)acrylate compounds M1 as defined for component A.

Preferably, component B comprises the same (meth)acrylate compound M1 as in component A.

Component B may comprise more than 5% by weight of compound(s) M1, preferably more than 20% by weight, advantageously more than 50% by weight of compound(s) M1, preferably even more than 70% by weight, and even more preferentially more than 90% by weight, relative to the total weight of said component B.

Component B may notably comprise from 60% to 99.9% by weight of compound(s) M1, and preferably from 80% to 99.5% by weight, relative to the total weight of said component B.

Preferably, the (meth)acrylate compound M1 of component B does not comprise any acid groups. The acid groups may be a phosphoric acid group, a thiophosphoric acid group, a phosphonic acid group, a sulfonic acid group, and a carboxylic acid group. For example, the (meth)acrylate compound M1 in component B is not 10-methacryloyloxydecyl dihydrogen phosphate.

### Composition

The crosslinkable two-component composition according to the invention may comprise at least one additive chosen from the group formed from catalysts, fillers, antioxidants, polymerization inhibitors, light stabilizers/UV absorbers, metal deactivators, antistatic agents, antifogging agents, foaming agents, biocides, plasticizers, lubricants, emulsifiers, colorants, pigments, rheological agents, impact modifiers, adhesion promoters, accelerants, optical brighteners, flame retardants, anti-seepage agents, nucleating agents, solvents, and mixtures thereof.

These additives may be present in component A and/or component B of the composition according to the invention.

As examples of plasticizers that may be used, mention may be made of any plasticizer usually used in the field of adhesives, for instance epoxy resins, phthalates, benzoates, trimethylolpropane esters, trimethylolethane esters, trimethylolmethane esters, glycerol esters, pentaerythritol esters, naphthenic mineral oils, adipates, cyclohexyldicarboxylates, paraffinic oils, natural oils (optionally epoxidized), polypropylenes, polybutylenes, hydrogenated polyisoprenes, and mixtures thereof.

For example, use may be made of:
diisodecyl phthalate, for instance sold under the name Palatinol™ DIDP by the company BASF,
a phenol ester of an alkylsulfonic acid, for instance sold under the name Mesamoll® by the company Lanxess,
diisononyl 1,2-cyclohexanedicarboxylate, for instance sold under the name Hexamoll Dinch® by the company BASF,
pentaerythrityl tetravalerate, for instance sold under the name Pevalen™ by the company Perstorp,
epoxidized soybean oil, for instance sold under the name Vikoflex® 7170 by the company Arkema.

As examples of rheological (thixotropic) agents that may be used, mention may be made of any rheological agent usually used in the field of adhesive compositions.

Preferably, the thixotropic agents are chosen from:
PVC plastisols, corresponding to a suspension of PVC in a PVC-miscible plasticizer, obtained in situ by heating at temperatures ranging from 60° C. to 80° C. These plastisols may be those described notably in the book “Polyurethane Sealants”, Robert M. Evans, ISBN 087762-998-6,
fumed silica, for instance sold under the name HDK® N20 by Wacker;
urea derivatives resulting from the reaction of an aromatic diisocyanate monomer such as 4,4′-MDI with an aliphatic amine such as butylamine. The preparation of such urea derivatives is notably described in patent application FR 1 591 172;
micronized amide waxes, such as Crayvallac® SLT or Crayvallac® SLA sold by Arkema.

The composition according to the invention may also comprise at least one organic and/or mineral filler.

The mineral filler that may be used is advantageously chosen so as to improve the mechanical performance of the composition according to the invention in the crosslinked state.

By way of example of mineral filler that may be used, any mineral filler usually used in the field of adhesive compositions may be used. These fillers are typically in the form of particles of various geometries. For example, they may be spherical, fibrous or irregular in shape.

Preferably, the filler is chosen from the group formed from clay, quartz, carbonate fillers, kaolin, gypsum, and mixtures thereof; preferentially, the filler is chosen from carbonate fillers, such as alkali metal or alkaline-earth metal carbonates, and more preferentially calcium carbonate or chalk.

These fillers may be untreated or treated, for example with an organic acid such as stearic acid, or a mixture of organic acids formed predominantly from stearic acid.

Mineral hollow microspheres such as glass hollow microspheres, and more particularly those made of sodium calcium borosilicate or aluminosilicate, may also be used.

The filler may be electrically and/or thermally conductive.

Among the electrically conductive fillers, mention may be made, for example, of carbon black, graphite, carbon fibers, a metal M′ optionally coated with a layer of metal M″, a mineral or organic filler coated with a layer of metal, and mixtures thereof.

Among the metals coated with a metal layer, mention may be made, for example, of copper coated with a silver layer.

The organic fillers may be coated with a layer of metal such as silver or copper. Mention may be made, for example, of polymethyl methacrylate (PPMA) coated with a layer of silver.

Among the thermally conductive fillers, mention may be made, for example, of carbon black powders, graphite, carbon fibers (CNT), metal oxides, metal hydroxides, metal silicates, metal sulfides, boron nitride and aluminum nitride. The metals of the metal compounds are chosen, for example, from tin, indium, antimony, aluminum, titanium, iron, magnesium, zinc, etc. The electrically and/or thermally conductive fillers may be in the form of spherical particles, tubes, flakes or fibers having, in particular, a specific surface area ranging from 0.01 m²/g to 100 m²/g.

Preferably, the composition comprises electrically conductive fillers.

The composition according to the invention may comprise from 0% to 95% by weight and preferably from 40% to 95% by weight of one or more electrically and/or thermally conductive fillers relative to the total weight of said composition.

Preferably, the electrically and/or thermally conductive fillers are in component B of said composition.

The composition according to the invention may also comprise at least one adhesion promoter, preferably chosen from silanes, such as aminosilanes, epoxysilanes or acryloyl silanes, or phosphate ester-based adhesion promoters, for instance 2-hydroxyethyl methacrylate phosphate ester, 2-methacryloyloxyethyl phosphate, bis(2-methacryloyloxyethyl phosphate), 2-acryloyloxyethyl phosphate, bis(2-acryloyloxyethyl phosphate), methyl(2-methacryloyloxyethyl phosphate), ethyl(2-methacryloyloxyethyl phosphate), a mixture of 2-hydroxyethyl methacrylate mono- and di-phosphate esters.

When a pigment is present in the composition, its content is preferably less than or equal to 3% by weight, and more preferably less than or equal to 2% by weight, relative to the total weight of the composition. When it is present, the pigment may represent, for example, from 0.1% to 3% by weight or from 0.4% to 2% by weight relative to the total weight of the composition.

The pigments may be mineral or organic pigments.

For example, the pigment is TiO₂, in particular Kronos® 2059 sold by the company Kronos.

The composition may comprise an amount of from 0.1% to 3%, preferably from 1% to 3% by weight, of at least one UV stabilizer or antioxidant. These compounds are typically introduced to protect the composition from degradation resulting from a reaction with oxygen which may be formed by the action of heat or light. These compounds may include primary antioxidants that scavenge free radicals. The primary antioxidants may be used alone or in combination with other secondary antioxidants or UV stabilizers.

Examples that may be mentioned include Irganox® 1010, Irganox® B561, Irganox® 245, Irgafos® 168, Tinuvin® 328 or Tinuvin™ 770 sold by BASF.

According to a preferred embodiment, the two-component composition according to the invention does not comprise any peroxide.

According to a preferred embodiment, the two-component composition according to the invention does not comprise any quaternary ammonium salt such as, for example, dilauryldimethylammonium chloride or dodecyltrimethylammonium chloride.

In the composition according to the invention, the component A/component B volumetric ratio may range from 20/1 to 1/1, preferentially from 10/1 to 1/1. The A/B volumetric ratio is preferably 1/1, which was not possible with peroxide/tertiary amine systems.

### B. Ready-to-Use Kit

The present invention also relates to a ready-to-use kit, comprising component A as defined above, on the one hand, and component B as defined above, on the other, packaged in two separate compartments. This may, for example, be a two-component cartridge.

Specifically, the composition according to the invention may be found in a two-component form, for instance within a ready-to-use kit, comprising component A on the one hand in a first compartment or drum and component B on the other hand in a second compartment or drum, in proportions suitable for direct mixing of the two components, for example with the aid of a metering pump.

According to one embodiment of the invention, the kit also comprises one or more means for mixing components A and B. Preferably, the mixing means are chosen from metering pumps, static mixers with diameters suitable for the amounts used.

### C. Uses of the Composition

The present invention also relates to the use of a crosslinkable two-component composition as defined above, as an adhesive, mastic or coating, preferably as an adhesive.

The invention also relates to the use of said composition for structural or semi-structural repair and/or adhesive bonding of materials, for example in the transportation, automotive (car, bus or truck), assembly, marine, electronics or construction fields.

The present invention relates to a process for assembling two substrates by adhesive bonding, which involves:
mixing components A and B as defined above to form the composition as defined above;
coating at least one of the two substrates to be assembled with said composition;
effectively placing the two substrates in contact; and then
crosslinking the composition.

The crosslinking step may be performed at a temperature of between 0° C. and 200° C., preferably between 10° C. and 150° C., preferably between 23° C. and 80° C. and in particular between 20° C. and 25° C.

Suitable substrates are, for example, inorganic substrates such as concrete, metals or alloys (such as aluminum alloys, steel, nonferrous metals and galvanized metals); or organic substrates such as wood, plastics such as PVC, polycarbonate, PMMA, polyethylene, polypropylene, polyesters, epoxy resins; metal substrates and painted composites.

The crosslinking may be performed under electromagnetic irradiation, for instance with a UV radiation source or an LED. The electromagnetic irradiation may be performed on the bonding edges in the case of an opaque substrate, or directly through the substrate in the case of a transparent substrate.

The crosslinking step under electromagnetic irradiation may be performed at a wavelength greater than 300 nm, preferably ranging from 360 nm to 680 nm, and even more preferentially from 360 nm to 420 nm.

The inventors have advantageously discovered that the open time can be varied notably by varying different parameters such as the nature or content of organocopper derivative(s) and/or of sulfinate(s). The presence of photoinitiator P1 and/or submission to electromagnetic irradiation also advantageously allow the open time to be reduced.

Moreover, the compositions advantageously show rapid cohesion build-up, irrespective of the open time (short in the electronics field, or long in the wind power field). Furthermore, the compositions according to the invention advantageously show good adhesive properties, and advantageously lead to surfaces free of tack after bonding.

The composition according to the invention is advantageously suitable for transportation relative to peroxide-based compositions.

The present invention also relates to a method for determining the crosslinking of a crosslinkable two-component composition as defined above, comprising a step of mixing components A and B as defined above.

All the embodiments defined above for the crosslinkable two-component composition and also components A and B apply for the present method.

The mixing step may be performed for a time ranging from 30 seconds to 1 minute.

During the initial mixing of components A and B, the composition is advantageously colored, in particular blue when the organocopper derivative is an organocopper (II) derivative; this notably makes it possible to check that the mixture of parts A and B is homogeneous. During the crosslinking step, the composition advantageously changes color.

This change in the color of the composition advantageously makes it possible to monitor and determine when the composition is polymerizing/crosslinking. This advantageous effect makes it possible to avoid the use of additional coloring agents and to verify by simple visual observation that the mixing is efficient and that polymerization/crosslinking is effective, thus facilitating end-user use.

All the embodiments described above may be combined together. In particular, the various abovementioned constituents of the composition, and notably the preferred modes, of the composition may be combined together.

In the context of the invention, the term “between x and y” or “ranging from x to y”, means an interval in which the limits x and y are included. For example, the range “between 0% and 25%” notably includes the values 0% and 25%.

The invention is now described in the following examples, which are given for illustrative purposes only, and should not be interpreted as limiting its scope.

### EXAMPLES

The following ingredients were used:
SR® 506 D: isobornyl acrylate (IBOA) (CAS No.: 5888-33-5) sold by Arkema;
SR® 531: cyclic trimethylolpropane formal acrylate (CAS No.: 66492-51-1) sold by Arkema;
Cu(acac)₂: copper(II) acetylacetonate (CAS No.: 13395-16-9) from Sigma-Aldrich;
Cu(3FAA)₂: anhydrous copper(II) trifluoroacetate (CAS No.: 123333-88-0) from Sigma-Aldrich;
sodium p-toluenesulfinate (CAS No.: 824-79-3) from Sigma-Aldrich;
2FAA: difluoroacetic acid (CAS No.: 381-73-7) from Sigma-Aldrich.

### Example 1: Preparation of Composition 1 (According to the Invention)

In a mixer maintained with constant stirring and under air, the ingredients of component A are mixed in the proportions indicated in the following table at a temperature of 23° C.

In a mixer maintained with constant stirring and under air, the various ingredients constituting component B are mixed in the proportions indicated in the following table at a temperature of 23° C.

TABLE 1
Composition 1 according to the invention

| Component A | | Component B | |
|---|---|---|---|
| | weight % | | weight % |
| | (relative to the | | (relative to the |
| Ingredients | total weight of A) | Ingredients | total weight of B) |
| SR ®531 | 97.5 | SR@531 | 99 |
| Cu(acac)₂ | 0.5 | Sodium p- | 1 |
| | | toluenesulfinate | |
| 2FAA | 2 | | |
| TOTAL | 100 | TOTAL | 100 |

Component A and component B are mixed in a volumetric ratio of 1:1 using a Sulzer® mixpac mixer at a room temperature of 23° C.

### Example 2: Preparation of Composition 2 (According to the Invention)

In a mixer maintained with constant stirring and under air, the ingredients of component A are mixed in the proportions indicated in the following table at a temperature of 23° C. In a mixer maintained with constant stirring and under air, the various ingredients constituting component B are mixed in the proportions indicated in the following table at a temperature of 23° C.

TABLE 2
Composition 2 according to the invention

| Component A | | Component B | |
|---|---|---|---|
| | weight % | | weight % |
| | (relative to the | | (relative to the |
| Ingredients | total weight of A) | Ingredients | total weight of B) |
| SR ®506D | 97.5 | SR@506D | 99 |
| Cu(acac)₂ | 0.5 | Sodium p- | 1 |
| | | toluenesulfinate | |
| 2FAA | 2 | | |
| TOTAL | 100 | TOTAL | 100 |

Component A and component B are mixed in a volumetric ratio of 1:1 using a Sulzer® mixpac mixer at a room temperature of 23° C.

### Example 3: Preparation of Composition 3 (According to the Invention)

In a mixer maintained with constant stirring and under air, the ingredients of component A are mixed in the proportions indicated in the following table at a temperature of 23° C.

In a mixer maintained with constant stirring and under air, the various ingredients constituting component B are mixed in the proportions indicated in the following table at a temperature of 23° C.

TABLE 3
Composition 3 according to the invention

| Component A | | Component B | |
|---|---|---|---|
| | weight % | | weight % |
| | (relative to the | | (relative to the |
| Ingredients | total weight of A) | Ingredients | total weight of B) |
| SR@531 | 99 | SR ®531 | 99 |
| Cu(3FAA)₂ | 1 | Sodium p- | 100 |
| | | toluenesulfinate | |
| TOTAL | 100 | TOTAL | 100 |

Component A and component B are mixed in a volumetric ratio of 1:1 using a Sulzer® mixpac mixer at a room temperature of 23° C.

### Example 4: Performance of the Compositions

### Reactivity Measurement

The exotherm is continuously analyzed using a pyrometer and by thermal imaging.

The peak time is the time required to reach the peak temperature (maximum exotherm found during polymerization), as opposed to the pot life (or lag time), which is the time required for the sample to begin to polymerize.

Time/temperature profiles were produced using an Omega OS552-V1-6 industrial infrared thermometer (Omega Engineering®, Inc., Stamford, CT) accurate to ±1° C. for 2 g (about 4.0 mm height) and 0.25 g (1.4 mm height) of polymerization.

### Bonding Test

Deposit composition 1, 2 or 3 (obtained respectively in Examples 1, 2 or 3 by mixing components A and B with a Sulzer® mixpac mixer) on a first glass microscope slide (25×76 mm);
Affix a second glass microscope slide (25×76 mm) on the first slide which has received composition 1, 2 or 3;
Slide the two microscope slides to allow equal distribution of composition 1, 2 or 3 between the two slides (oxygen exposure is reduced here).

The bonding time is the time after which it is no longer possible to separate the two slides.

### Stability

A bottle containing 10 g of component A and a bottle containing 10 g of component B (from one of the compositions 1, 2 or 3) under air are closed and placed at 40° C. in an oven.
Each week, 1.5 g of each component are collected using a pipette, and then placed in the two compartments of a medmix mixpac dual-cartridge mixer (Sulzer).
On mixing, the reactivity is conventionally monitored using the apparatus described previously for measuring the peak time.

The formulation is declared unstable when this peak time is no longer observed, whereas it was observed at earlier times.

TABLE 4

| | Peak | Temperature | Bonding | | Stability | |
|---|---|---|---|---|---|---|
| Composition | time (s) | peak (in ° C.) | time (in s) | Comments | at 40° C. | |
| Composition 1 | 2 min 12 | 140° C. | 3 min | No tack | 4 | weeks |
| (Example 1) | sec | | | | | |
| Composition 2 | 3 min 30 | 140° C. | 5 min | No tack | 4 | weeks |
| (Example 2) | sec | | | | | |
| Composition 3 | 2 min 38 | 120° C. | nd | No tack | <1 | week |
| (Example 3) | sec | | | | | |

nd = not determined

The peak times of compositions 1, 2 and 3 according to the invention are advantageously short, and the exothermicity is high, characterizing good reactivity (cohesion build-up). The bonding times are also short, and the surfaces are free of residual tack.

1-22. (canceled)

23. A crosslinkable two-component composition comprising:
a component A comprising:
an organocopper derivative; and
at least one (meth)acrylate compound M1;
on condition that when the organocopper derivative of component A is not halogenated, then component A also comprises a halogenated carboxylic acid;
a component B comprising at least one compound having the formula (VI) below:
[R^{a}—SO₂⁻]ₚ, Q^{P+} (VI)
in which:
R^{a} represents an aryl or heteroaryl radical, said heteroaryl and aryl being optionally substituted with at least one of the following radicals: F, OH, C(O)OMe, NHC(O)Me, methyl(Me), CF₃, OH or SO₂⁻;
Q represents Li, Na, K, or Zn; and
p represents 1 or 2.

24. The composition as claimed in claim 23, characterized in that the organocopper derivative is chosen from the group formed from a copper salt of formula (VII-1) or a copper complex of formula (VII-2): 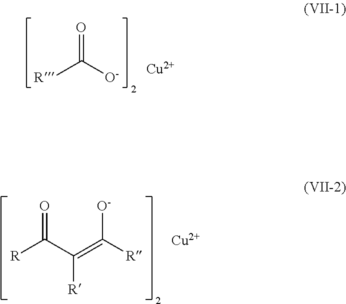
in which:
R and R″ each represent, independently of each other, an alkyl radical, a cycloalkyl radical, an aryl radical or a heteroaryl radical, said alkyl, cycloalkyl, aryl and heteroaryl radicals being optionally substituted with one or more halogen atoms, for instance with one or more fluorine atoms;
R′ represents a hydrogen atom, an alkyl radical, a cycloalkyl radical, an aryl radical or a heteroaryl radical,
or R and R′ (or R′ and R″) may also be engaged in one and the same ring comprising from 5 to 8 carbon atoms, said ring optionally comprising at least one heteroatom;
R′″ represents an alkyl radical, a cycloalkyl radical, an aryl radical or a heteroaryl radical, said alkyl, cycloalkyl, aryl, and heteroaryl radicals being optionally substituted with one or more halogen atoms.

25. The composition as claimed in claim 23, characterized in that the organocopper derivative is a copper salt of formula (VII-1) in which R′″ represents an alkyl radical containing from 1 to 20 carbon atoms, said alkyl being optionally substituted with one or more halogen atoms, for instance with one or more fluorine atoms.

26. The composition as claimed in claim 23, characterized in that the organocopper derivative is a copper salt of formula (VII-2) in which:
R represents an alkyl radical, a cycloalkyl radical, an aryl radical or a heteroaryl radical;
R′ represents a hydrogen;
R″ represents an alkyl radical optionally substituted with one or more halogen atoms, for instance one or more fluorine atoms.

27. The composition as claimed in claim 23, characterized in that the organocopper derivative of component A is not halogenated.

28. The composition as claimed in claim 23, characterized in that the total content of organocopper derivative(s) ranges from 0.05% to 5% by weight, relative to the total weight of the crosslinkable two-component composition.

29. The composition as claimed in claim 23, characterized in that the halogenated carboxylic acid is chosen from monohalogenated (comprising one halogen atom), dihalogenated (comprising two halogen atoms) or trihalogenated (comprising three halogen atoms) carboxylic acids.

30. The composition as claimed in claim 23, characterized in that the halogenated carboxylic acid is chosen from the group formed from monochloroacetic acid, monofluoroacetic acid, dichloroacetic acid, difluoroacetic acid, trichloroacetic acid, trifluoroacetic acid, and mixtures thereof.

31. The composition as claimed in claim 23, characterized in that, when they are present, the total content of halogenated carboxylic acid(s) ranges from 0.5% to 20% by weight, relative to the total weight of the crosslinkable two-component composition.

32. The composition as claimed in claim 23, characterized in that the (meth)acrylate compound M1 is a (meth)acrylate monomer, a (meth)acrylate oligomer or a (meth)acrylate polymer.

33. The composition as claimed in claim 23, characterized in that compound M1 has the formula (F) below: 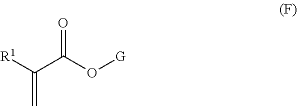
in which:
R¹ represents H or methyl;
G represents an organic radical.

34. The composition as claimed in claim 23, characterized in that compound M1 has one of the formulae (I), (II), (III), (IV) or (V) below: 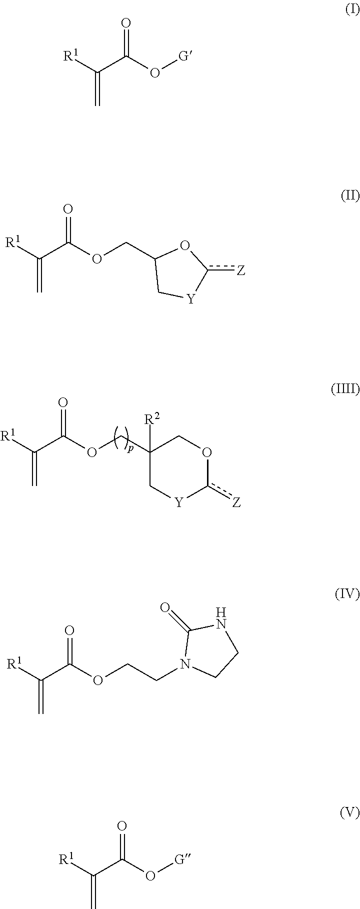
in which:
R¹ represents H or methyl;
R² represents H, methyl or ethyl;
p represents 0 or 1; and
Z represents H, O, S, an alkyl group, a benzyl group, an aryl group or an alkoxy group;
Y represents O, S, NH or CH₂; [symbol]
is a single or double bond,
on condition that when Z represents O, then the bond [symbol] is a double bond;
G′ is chosen from the group formed from alkyls, cycloalkyls, alkenyls, cycloalkenyls, alkylaryls, arylalkyls or aryls, said alkyls, cycloalkyls, alkenyls, cycloalkenyls, alkylaryls, arylalkyls and aryls being optionally substituted with an alkyl group, said G′ group being characterized in that it does not comprise any heteroatoms;
G″ is an alkyl substituted with an OH group.

35. The composition as claimed in claim 34, characterized in that, in formula (I), G′ is chosen from the group formed from C1 to C20 alkyls, cycloalkyls or aryls, said alkyls, cycloalkyls and aryls being optionally substituted with an alkyl group, said group G′ being characterized in that it does not comprise any heteroatoms.

36. The composition as claimed in claim 23, characterized in that:
the compounds of formula (I) are chosen from methyl (meth)acrylate, 2-ethylhexyl (meth)acrylate, n-butyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, bornyl (meth)acrylate, 2,3,4,5-tetra-t-butylcyclohexyl (meth)acrylate; benzyl (meth)acrylate, phenyl (meth)acrylate, 2-(2-ethoxyethoxy)ethyl (meth)acrylate, 2-phenoxyethyl (meth)acrylate, isobornyl (meth)acrylate, and mixtures thereof;
the compounds of formula (II) are chosen from the following monomers: 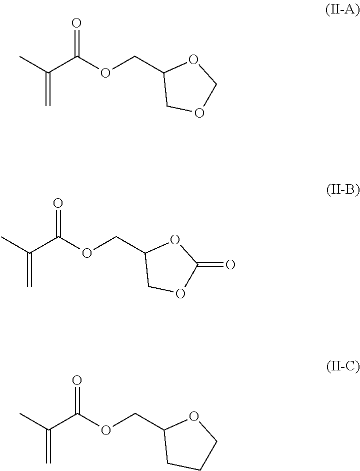
the compounds of formula (III) are chosen from the following monomers: 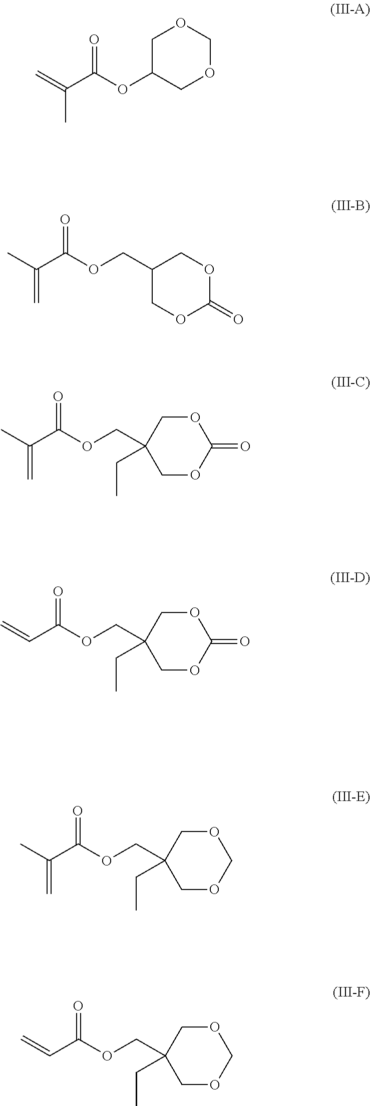 [SMILES: C=C(C)C(=O)OC1COCOC1 ; C=C(C)C(=O)OCC1COC(=O)OC1 ; C=C(C)C(=O)OCC1(CC)COC(=O)OC1 ; C=CC(=O)OCC1(CC)COC(=O)OC1 ; C=C(C)C(=O)OCC1(CC)COCOC1 ; C=CC(=O)OCC1(CC)COCOC1]
the compounds of formula (V) are chosen from hydroxyethyl (meth)acrylate and hydroxypropyl (meth)acrylate.

37. The composition as claimed in claim 23, characterized in that the total content of (meth)acrylate compound(s) M1 in component A is greater than or equal to 5% by weight, relative to the total weight of said component A.

38. The composition as claimed in claim 23, characterized in that the compound of formula (VI) is chosen from the following compounds:

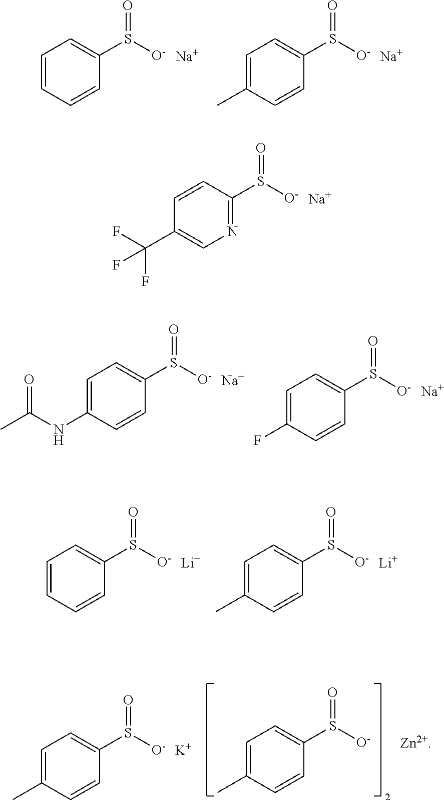

39. The composition as claimed in claim 23, characterized in that it comprises at least one additive chosen from the group formed from catalysts, fillers, antioxidants, polymerization inhibitors, light stabilizers/UV absorbers, metal deactivators, antistatic agents, antifogging agents, foaming agents, biocides, plasticizers, lubricants, emulsifiers, colorants, pigments, rheological agents, impact modifiers, adhesion promoters, accelerants, optical brighteners, flame retardants, anti-seepage agents, nucleating agents, solvents, and mixtures thereof.

40. The composition as claimed in claim 39, characterized in that the filler is an electrically or thermally conductive filler.

41. A ready-to-use kit, comprising component A and component B as defined in claim 23, wherein component A and component B are packaged in two separate compartments.

42. An adhesive, mastic or coating comprising the crosslinkable two-component composition as defined in claim 23.

43. A process for assembling two substrates by adhesive bonding, which involves:
mixing components A and B as defined in claim 23 to form the composition as defined in claim 23;
coating at least one of the two substrates to be assembled with said composition;
effectively placing the two substrates in contact; and then
crosslinking the composition.

44. A method for determining the crosslinking of a crosslinkable two-component composition as defined in claim 23, comprising a step of mixing components A and B as defined in claim 23, characterized in that during the initial mixing of components A and B, the composition is colored, and during the crosslinking step, the composition changes color.
